(19) United States
(12) Patent Application Publication
(10) Pub. No.: US 2019/0014726 A1
(43) Pub. Date: Jan. 17, 2019

(54) CROP GROWTH ENHANCEMENT TECHNOLOGY

(71) Applicants: Stewart E. Erickson, Hudson, WI (US); Rick Berglund, Hudson, WI (US); Rob McPherson, Hudson, WI (US)

(72) Inventors: Stewart E. Erickson, Hudson, WI (US); Rick Berglund, Hudson, WI (US); Rob McPherson, Hudson, WI (US)

(21) Appl. No.: 16/037,485

(22) Filed: Jul. 17, 2018

Related U.S. Application Data
(60) Provisional application No. 62/533,218, filed on Jul. 17, 2017.

(51) Int. Cl. A01G 9/18; B01D 53/22; A01G 9/24; A01G 7/02

(52) U.S. Cl. CPC A01G 9/18; B01D 53/229; A01G 9/246; B01D 2259/4508; B01D 2259/10; B01D 2259/12; A01G 7/02

(57) ABSTRACT

A system, apparatus and method of enhancing the growth of crops using gaseous media with deprived Oxygen content. A plant growth apparatus is disclosed including a source of Nitrogen gas (N2); a source of Carbon Dioxide gas (CO2 gas); a compressor connected to the source of Nitrogen gas and to the source of CO2 gas; and one or more gas emitters connected to the compressor and adapted to be disposed near plants in a greenhouse or other enclosure. During use, the gas emitters emit a predetermined amount of Nitrogen gas and a predetermined amount of CO2 gas, in a mixture, to the plants, whereby a diffusion gradient is created in each plant moving Oxygen gas (O2) out of the plant and enhancing photosynthesis in the plant.

### CROSS-REFERENCE TO RELATED APPLICATIONS, IF ANY

This application, claims the benefit under 35 U.S.C. § 119(e) of co-pending. U.S. Provisional Patent Application Ser. No. 62/533,218, fifed Jul. 17, 2017, which is hereby incorporated by reference.

### 37 C.F.R. § 1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

### 1. Field of the Invention

The present invention relates, generally, to agricultural systems, apparatus and methods. Particularly, the invention, relates to a crop growth enhancement system, apparatus and method. Most particularly, the invention relates to a system, apparatus and method of enhancing the growth of crops using gaseous media with deprived Oxygen content.

### 2. Background Information

Referring to FIGS. 1-5, plant leaves are essentially sugar factories. In the process of making sugars, Carbon Dioxide (CO₂) enters a leaf via stomata and an Oxygen Gas (O₂) byproduct is discharged. While O₂ gas is daily seeking discharge during daylight hours, with supplemented CO₂ gas, the photosynthetic reaction is accelerated and the stomata close/restrict. Thus, there is a more rapid production of O₂, exasperating buildup of O₂ gas inside the inner leaf space, as the plant desperately requires to diffuse the byproduct O₂ gas out of the leaf to the surrounding air.

Unlike humans that use Bulk Flow and muscular energy to displace large volumes of gas during breathing, plants are totally dependent on the process of molecular diffusion for their “breathing” gas exchange. The process is so innocuous that it has been largely overlooked by scientists, agronomists, and farmers alike.

Diffusion is the mechanism that moves O₂ (the exhaust gas from photosynthesis) out of the inner leaf space to the surrounding atmosphere on the outside of the leaf. Diffusion is the net movement of molecules or atoms from a region of high concentration (or high chemical potential) to a region of low concentration (or low chemical potential). This is also referred to as the movement of a substance down a concentration gradient. A gradient is the change in the value of a quantity (e.g., concentration, pressure, temperature) with the change in another variable (usually distance). For example, a change in concentration over a distance is called a concentration gradient, a change in pressure over a distance is called a pressure gradient, and a change in temperature over a distance is a called a temperature gradient.

In the phenomenological approach, diffusion is the movement of a substance from a region of high concentration to a region of low concentration without bulk motion. According to Fick's laws, the diffusion flux is proportional to the negative gradient of concentrations. It goes from regions of higher concentration to regions of lower concentration. Sometime later, various generalizations of Fick's laws were developed in the frame of thermodynamics and non-equilibrium thermodynamics.

From the atomistic point of view, diffusion is considered as a result of the random walk of the diffusing particles. In molecular diffusion, the moving molecules are self-propelled by thermal energy. Random walk of small particles in suspension in a fluid was discovered in 1827 by Robert Brown. The theory of the Brownian motion and the atomistic backgrounds of diffusion were developed by Albert Einstein. The concept of diffusion is typically applied to any subject matter involving random walks in ensembles of individuals.

In biology, the terms “net movement” or “net diffusion” are often used when considering the movement of ions or molecules by diffusion. For example, oxygen diffuse through cell membranes and if there is a higher concentration of oxygen outside the cell than inside, oxygen molecules will diffuse into the cell. However, because the movement of molecules is random, occasionally oxygen molecules will move out of the cell (against the concentration gradient). Because there are more oxygen molecules outside the cell, the probability that oxygen molecules will enter the cell is higher than the probability that oxygen molecules will leave the cell. Therefore, the “net” movement of oxygen molecules (the difference between the number of molecules either entering or leaving the cell) will be into the cell. In other words, there will be a net movement of oxygen molecules down the concentration gradient.

The theory of diffusion in gases is based on Bolzmann's equation. In Boltzmann's kinetics of the mixture of gases, each gas has its own distribution function:

fᵢ(x,c,t)
where t is the time moment, x is position and c is velocity of molecule of the with component of the i^{th} component of the mixture.
   Each component has its mean velocity

Cᵢ(x,t)=1/nᵢ integral c cf(x,c,t)dc

If the velocities do not coincide then there exists diffusion.

The invention involves blending in an inert gas, preferably Nitrogen (N₂) to replace for the O₂, non-toxic to plants. Nitrogen is a common element. On Earth, the element forms about 78% of Earth's atmosphere and is the most abundant uncombined element. Nitrogen gas is an industrial gas produced by the fractional distillation of liquid air, or by mechanical means using gaseous air (i.e., pressurized reverse osmosis membrane or pressure swing adsorption). Nitrogen gas generators using membranes or Pressure Swing Absorption (PSA) are typically more cost and energy efficient than bulk delivered nitrogen. Commercial nitrogen is often a byproduct of air-processing for industrial concentration of oxygen for steelmaking and other purposes. When supplied compressed in cylinders it is often called OFN (oxygen-free Nitrogen).

Industrial facilities produce gaseous nitrogen or oxygen products using near-ambient-temperature separation processes. Non-cryogenic separation processes are most commonly used when high purify nitrogen or oxygen is not needed (e.g. to produce nitrogen which is 98 to 99.5% oxygen-free, or oxygen at about 93% purity) and when product demand is relatively low; for example: nitrogen at production rates less than about 20,000 scfh/500 Nm³ or oxygen at production rates less than about 55,000 scfh/1500 Nm³. There are two major types of non-cryogenic processes: selective adsorption and differential permutation through membranes to produce relatively pure oxygen or nitrogen. These air separation processes use differences in properties such as molecular structure, size and mass to achieve the desired degree of product purity.

Rubisco is the enzyme responsible for the acquisition and transfer of CO₂ gas molecule from the inner leaf space, introducing the CO₂ molecule into the Calvin Cycle for conversion in the photosynthetic process converting the CO₂ into a sugar molecule. The gaseous O₂ molecules also present in the inner leaf apace are also actively “bumping into” the Rubisco enzyme receptor sites, therein actively competing with and blocking the CO₂ molecules from being more rapidly acquired into the photosynthetic process by the Rubisco enzyme. Therefore, as the present invention calls for the more rapid discharge of O₂ level from the inner leaf space by increasing the negative chemical gradient from the interior of the leaf to the exterior of the leaf, with such minus O₂ reduction results in the CO₂ uptake by the Rubisco enzyme to be accelerated, no matter whether the CO₂ level is at ambient 400 ppm, or enriched.

Existing technology in this field is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides an agricultural apparatus/method which are practical, reliable, accurate and efficient, and which is believed to fulfill the need and to constitute an improvement over the background technology.

The present invention seeks to decrease the O₂ on the exterior of the leaf surface thusly increasing chemical gradient (becomes greater), the rate of O₂ diffusion leaving the inner leaf space is accelerated, lowering the elevated O₂ concentration in the inner leaf space created by photosynthesis. The invention can be used in combination with CO₂ enrichment, because the CO₂ enrichment initiates stomata closure, which exasperates the O₂ build up inside the leaf space.

The known art involves introduction of CO₂ gaseous media to the crops. While this is beneficial to the crops, because the stomatal closure inhibits the discharge of O₂, the photosynthetic gas exchange is suppressed.

And greenhouses commonly use “burners” that consume propane or natural gas as fuel to produce CO₂ to CO₂ enrich the enclosed structure to around 1000-1500 part per million. While the burners consume oxygen in the combustion, process boosting the CO₂ from ambient 400 part per million to 1,000 PPM has a virtually undetectable impact on the overall O₂ content in the structure.

The invention seeks to significantly alter the O₂ content in the structure or around the plant in the out of doors, i.e. by more than 1% which would be O₂ is 210,000 PPM ambient move the dial by more than 10,000 PPM. Plus, in greenhouse's there is commonly a slight O₂ increase stemming resulting from the plants off-gassing O₂ as the byproduct of the photosynthetic process, so the current invention seeks to not only bring the O₂ level back down to ambient, but further described into a −O₂ state at 200,000 ppm or less.

And in outdoor CO₂ enrichment the CO₂ used is actually slight displacing O₂ in the air mixture, so that technology is slightly exasperating the O₂ chemical gradient required to move the photosynthetic O₂ derivative gas out of the inner leaf space.

In one aspect, the invention provides a system and method for accelerating plant growth using gaseous media surrounding the leaves of plants, the media being deprived of the normal ambient air O₂ concentrations (i.e. less than 21% oxygen −O₂). In another aspect, the invention provides to create a wider chemical gradient from inner leaf space to surrounding ambient air, thusly accelerating the rate of diffusion/discharge of O₂ gaseous byproduct of photosynthesis, providing accelerated Photosynthetic Activity Rate within the leaves, that is, the formation of photosynthates/sugars:

6CO₂+6H₂O=C₆H₁₂O₆+6O₂.

In another aspect, the invention provides a plant growth apparatus, including:

a source of Nitrogen gas (N2);

a source of Carbon Dioxide gas (CO2 gas);

a compressor connected to the source of Nitrogen gas and to the source of CO2 gas; and

at least one gas emitter connected to the compressor and adapted to be disposed near at least one plant;

whereby, during use, the gas emitter emits a predetermined amount of Nitrogen gas and a predetermined amount of CO2 gas, in a mixture, to the at least one plant, whereby a diffusion gradient is created in the plant moving Oxygen gas (O2) out of the at least one plant and enhancing photosynthesis in the at least one plant.

In yet another aspect, the invention provides a system for enhancing the growth of plants growing in a green house, hoop house, or other enclosure, including:

a. a source of Nitrogen gas (N2);

b. a source of Carbon Dioxide gas (CO2 gas);

c. a compressor connected to the source of Nitrogen gas and to the source of CO2 gas;

d. a plurality of gas emitters connected to the compressor and adapted to be disposed near the plants, whereby during use, the gas emitter emits a predetermined amount of Nitrogen gas and a predetermined amount of CO2 gas, in a mixture, to the plants, whereby a diffusion gradient is created in the plants moving Oxygen gas (O2) out of the plants and enhancing photosynthesis in the plants;

e. a gas flow control valve disposed between the compressor and the gas emitters;

f. at least one CO2 sensor and at least one O2 sensor disposed near the plants; and

g. an electronic control communicatively interconnected to the gas flow control valve, the at least one CO2 sensor, and the at least one O2 sensor, the electronic control provides a mixture of Nitrogen gas and CO2 gas to the plants such that, when emitted into ambient air surrounding the plants, creates a Minus O2 condition.

In still a further aspect, the invention provides a method of enhancing the growth of plants growing in a green house, hoop house, or other enclosure by removing O2 from the ambient air surrounding the plants thereby creating a diffusion gradient in the plants, moving Oxygen gas (O2) out of the plants and enhancing photosynthesis in the plants.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a graph illustrating the constituents of ambient air.

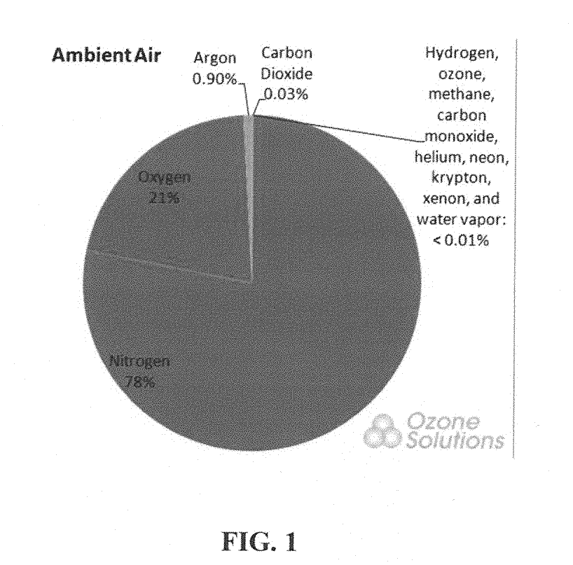

FIG. 2 is a diagram illustrating the basic physiological function of a plant leaf.

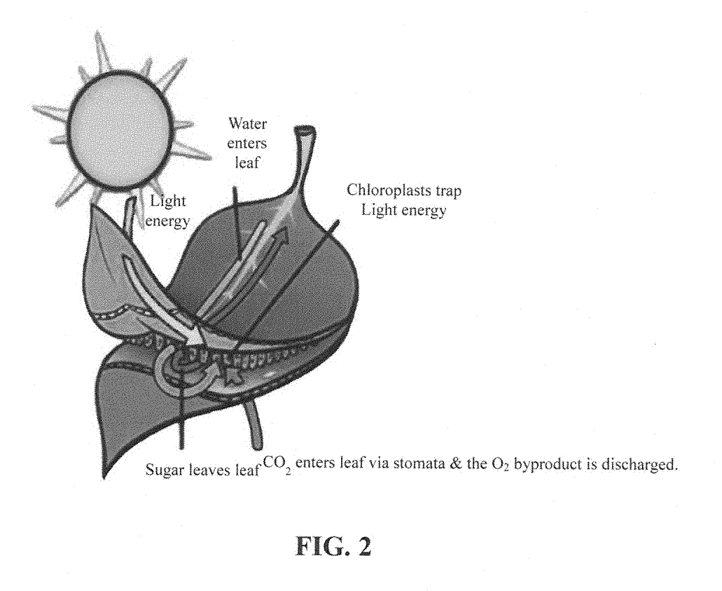

FIG. 3 is a diagram of the diffusion of gases in plant chemistry.

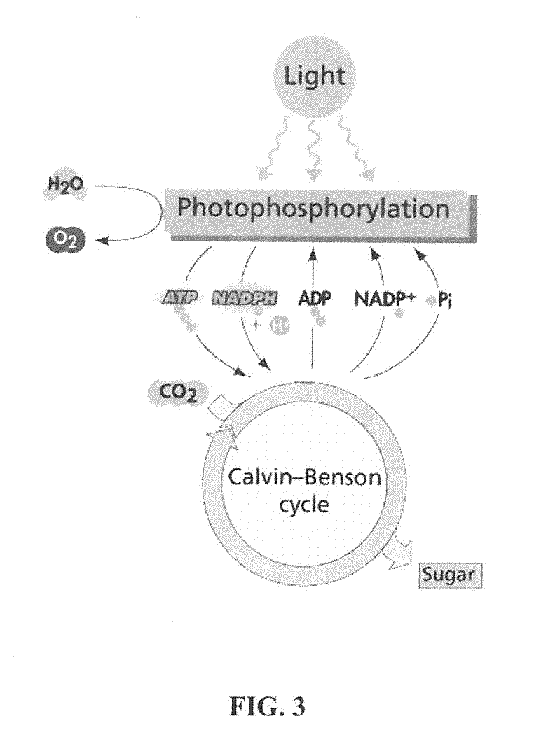

FIG. 4 is a further diagram illustrating gas diffusion.

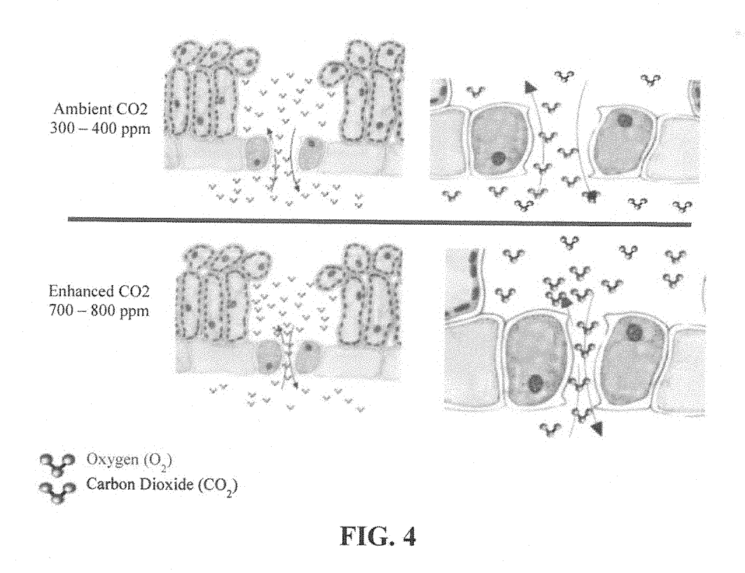

FIGS. 5A and 5B are photographs of plant stoma, in a group and individually, both open and closed.

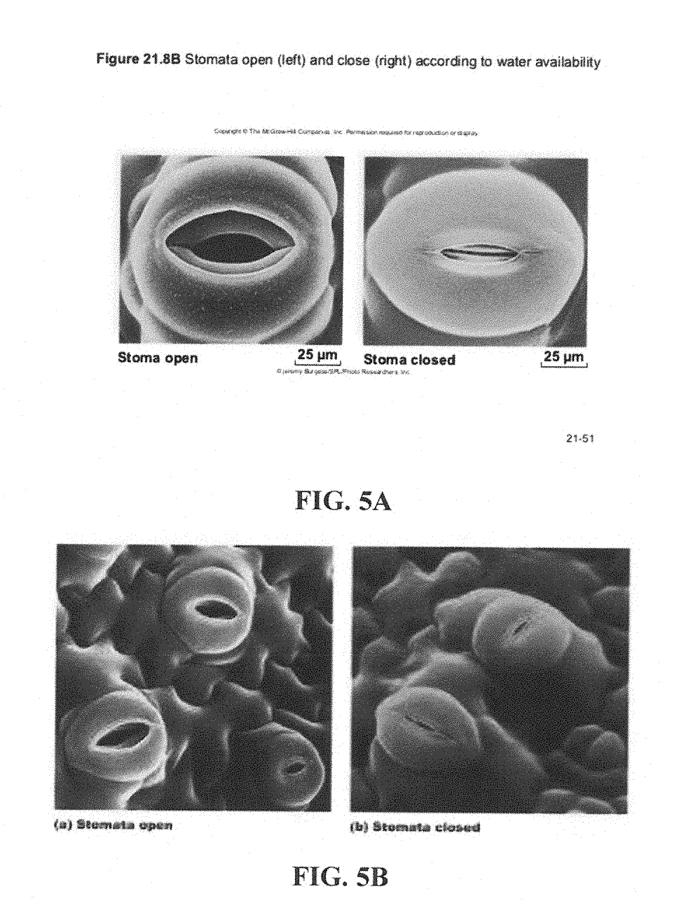

FIG. 6 is a diagram of an embodiment of a system of the invention.

### DETAILED DESCRIPTION

### 1. The Preferred Embodiments of the System and Method.

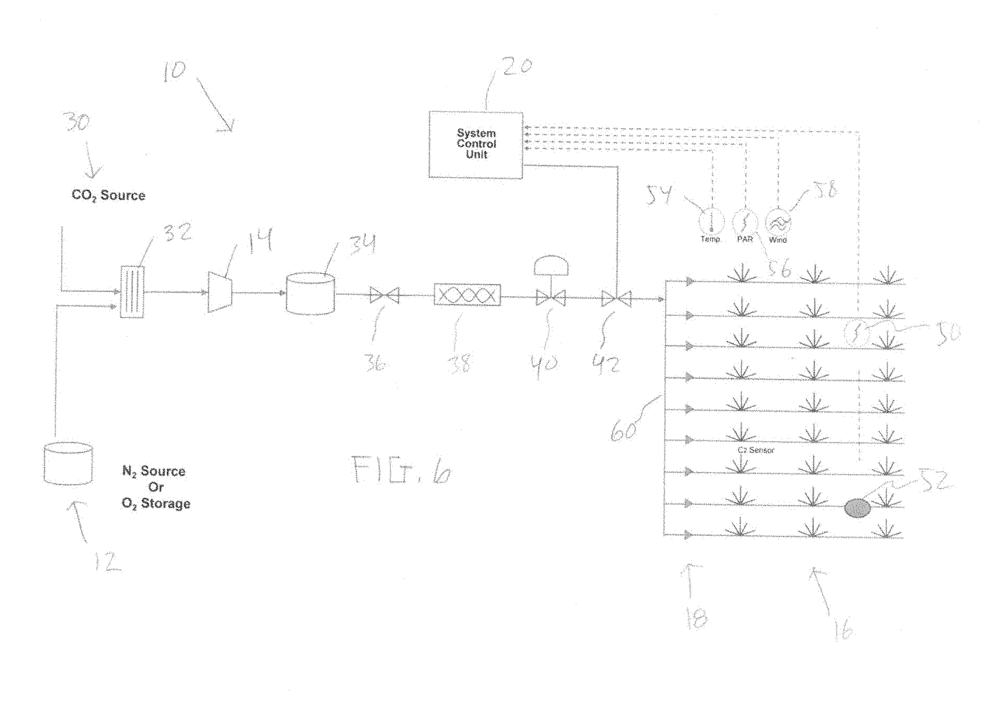

FIG. 6 shows embodiments of a Minos O2 system 10 of the present invention. CO₂ is a known aerial gaseous growth enhancer for crops. CO₂ and a Minus O₂ mix. (Nitrogen gas and CO₂ gas) are applied during daylight hours to further improve photosynthesis. O₂ deficient media and a higher than normal concentration of CO₂ provides optimal plant growth. Additionally, removal of O₂ from ambient air still further increases CO₂ concentration.

A basic embodiment includes a Nitrogen gas source 12 A, a CO2 gas source 30, a compressor 14, and interconnecting lines and manifolds to distribute N₂ (or deplete O₂) to a group of plants 16 based upon photosynthetic activity rates of the plants, via one or more emitters 18. Where more than one emitter 18 is deployed, the emitter may be connected to a manifold 60 which is interconnected to the output of the compressor 14. The Nitrogen gas (N2) source 12A may be a tank, either fixed or semi-portable. The CO2 gas source 30 may also be a tank. Alternatively, it may be a Pressure Swing Absorption Device (PSA). The plant group 16 includes a plurality of individual plants, which may be disposed in a greenhouse, hoop house or the like. Alternatively, the group may be disposed outside in a field, orchard, vineyard or the like.

In a more preferred embodiment, one or more sensors are preferably connected to a controller 20 to prescriptively add Minus (−) O₂ at a rate to accelerate the O₂ discharge from the leafy area of plant group 16.

The system 10 preferably provides a prescription of less than 20% O₂. This concentration is at least 1% lower than ambient air. Oxygen with a higher ambient concentration in the surrounding pool of air will diffuse inwardly rapidly towards the emitters 18. More preferably, the prescription rate is higher and matches the photosynthetic activity rate associated with photochemical reaction during high sunlight, at which time the plants' stomata opening are at their most open state therein buildup of unwanted O₂ gas byproduct in the interior leaf space and resulting reduction of photosynthesis.

The system introduces the prescriptive level or levels of −O₂ gas, with the balance composed of other nonreactive non-toxic gases. The other gases are not harmful to crops, but will increase the O₂ gradient across the inner and out leaf surface and immediately adjacent and surrounding the crops' leafy canopy. The flow rates of the distribution emitter array 18 is set so that just enough −O₂ is introduced so as to maintain an ongoing chemical gradient increase, occupies the leafy crop canopy and the immediately adjacent area so that O₂ is moving info the leafy area by diffusion or dispersion across the chemical gradient deficit created in the sphere by the neutralization process.

The application can be reversed at night to accommodate respiration from the plant group 16. In this case, O2 is stored in an O2 storage tank 12B. Nighttime application of stored O₂ enriched gas further facilitates improved respiration of plants.

Still referring to FIG. 6, a most preferred embodiment of the system 10 includes a CO2 source 30 input along with the N2 source 12, preferably to a filter 32. The output of the filter 32 is connected to the compressor 14. The compressor 14 output is connected to a CO2 storage 34. A valve 36 is interconnected between the output of the CO2 storage to a Venturi valve 38. The output of the venturi valve 38 is connected to a pressure regulator 40. The pressure regulator 40 is connected to a flow control valve 42, which controls flow to the emitter array 18. The flow control valve 42 is communicatively connected to the electronic controller 20. The sensors are also connected to the controller 20, The sensors preferably include a one or more CO2 sensors 50 and O2 sensors 52 disposed within the plant group 16, preferably closely proximate to the plant canopy. Sensors 50 and 52 may be disposed so that their position may be adjusted to remain close to the plant canopy and the plants 16 grow and mature. The sensors may also include a temperature sensor(s) 54, a PAR sensor(s) 56 and a wind sensor(s) 58.

CO2 sources 30 include ethanol plants, hydrogen fuel cells, natural gas fueled electric plaits, oil and gas refineries, and the like. N2 gas sources 12 include pressure swing absorption, industrial gases, non-cryogenic air separation systems, and the like.

When the system and method of the invention is employed in and enclosed space, the delivery systems would include audible alarms and visual warning lights to protect works from a deprived oxygen environment.

### 2. Other Embodiments of the System and Method.

Another way of achieving the lower percentage of O₂ in the system includes a PSA type hi-grade of nitrogen gas taking the N₂ concentration from 78% upwards of 79-99% and then adding CO₂. The Hi-grade gaseous media may be hooked to compression source, grid of tubes in a field of crops, to prescriptively distribute an O₂ deficient gaseous media into the atmosphere immersing a field of crops. The Hi-graded gaseous media may also be introduced into a greenhouse or indoor crop growing warehouse using lights such as medical and other marijuana growing facilities.

Deprived oxygen −O₂ gas is delivered in the distribution grid at a diluted ratio not to exceed 20% and desirably less than 5%. The delivering actuation and rate of delivery of the reagent is determined by the level of O₂ in the inner leaf space, so that the rate of O₂ release from the plant's leaves is accelerated, but does not vastly exceed the space occupied by the crops' foliar canopy. O₂ deprived delivery may be an aerial application as an airborne stimulator of carbohydrate formation in the leaves of plants.

An Air Separation Unit (ASU) may be used in opposing output during daytime and night time hours, with the −O₂ gas is delivered during the day (photosynthesis) and the “exhaust of the system is utilized at night +O₂ to enhance crop respiration. And where the derived oxygen is stored during daylight hours of segregation in compressed tanks, underground voids or other storage media, and then delivered to the crops at night through the same delivery systems when the crops are respiring (i.e. not photosynthesis). One source of non-toxic gas is a compressed tank.

For over forty years, industry has used oxygen in vast quantities as an industrial chemical, in medicine, and additive for fuel combustion for space exploration. During that time, industry has developed an infrastructure to produce, store, and transport and utilize oxygen safely. Likewise, for over 40 years, industry has used nitrogen in vast quantities as an industrial chemical for enhanced oil recovery, and other purposes. During that time, industry has developed an infrastructure to produce, store, and transport and utilize nitrogen safely. Odorless, colorless, tasteless, gas that makes up 78% of ambient air that we breath. Nitrogen safety concerns are not cause for alarm; they simply very inert and too high of concentration could cause asphyxiation (lack of oxygen). Nitrogen is inert but in too high of concentrations is dangerous under specific conditions. Nitrogen can be handled safely when simple guidelines are observed and the user has an understanding of its behavior.

Meanwhile, plants require hydrogen to form carbohydrates and sugars. CO2 enrichment can be costly, while creating a − (minus) O₂ media is less expensive. And the −O₂ media is super conductive in use with CO₂ enrichment and the delivery systems and points of utilization.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. A plant growth apparatus, comprising;
a source of Nitrogen gas (N2);
a source of Carbon Dioxide gas (CO2 gas);
a compressor connected to the source of Nitrogen gas and to the source of CO2 gas; and
at least one gas emitter connected to the compressor and adapted to be disposed near the at least one plant.

2. The apparatus of claim 1, wherein during use, the gas emitter emits a predetermined amount of Nitrogen gas and a predetermined amount of CO2 gas, in a mixture, to the at least one plant, whereby a diffusion gradient is created in the at least one plant moving Oxygen gas (O2) out of the at least one plant and enhancing photosynthesis in the at least one plant.

3. The apparatus of claim 2, wherein the mixture of Nitrogen gas and CO2 gas is such that, when emitted into ambient air surrounding the at least one plant, creates a Minus O2 condition.

4. The apparatus of claim 3, wherein the Minus O2 condition is approximately 1.0% less than ambient O2 concentration.

5. The apparatus of claim 3, wherein the Minus O2 condition is less than or equal to 200,000 ppm O2

6. The apparatus of claim 1, further comprising a niter connected to the input of the compressor, prior to the Nitrogen gas source and the CO2 source.

7. The apparatus of claim 1, further comprising a CO2 storage connected to the output of the compressor.

8. The apparatus of claim 1, further comprising at least one valve disposed between the compressor and the at least one emitter.

9. The apparatus of claim 8, wherein the at least one valve includes a venturi valve and a flow control valve.

10. The apparatus of claim 9, further comprising a pressure regulator connected between the venturi valve and the flow control valve.

11. The apparatus of claim 9, further comprising an electronic control communicatively connected to the flow control valve.

12. The apparatus of claim 11, further comprising at least one CO2 sensor disposed proximate the at least one plant and at least one O2 sensor disposed proximate the plant, the at least one CO2 sensor and the at least one O2 sensor being communicatively connected to the electronic control.

13. The apparatus of claim 12, further Comprising at least one temperature sensor connected to the electronic control.

14. The apparatus of claim 12, further comprising at least one PAR connected to the electronic control.

15. The apparatus of claim 12, further comprising at least one wind sensor connected to the electronic control.

16. The apparatus of claim 1, wherein the at least one emitter is a plurality of emitters connected to a manifold which is connected to the output of the compressor.

17. The apparatus of claim 16, wherein apparatus of adapted to emit Nitrogen gas and CO2 gas to a plurality of plants disposed in a greenhouse, hoop house, field, orchard, or vineyard.

18. The apparatus of claim 1, further comprising an O2 gas storage container, and wherein O2 gas generated by the at least one plant during nighttime, is drawn into the at least one emitter and transferred through the compressor to the O2 gas storage.

19. A system for enhancing the growth of plants growing in a green house, hoop house, or other enclosure, comprising:
a. a source of Nitrogen gas (N2);
b. a source of Carbon Dioxide gas (CO2 gas);
c. a compressor connected to the source of Nitrogen gas and to the source of CO2 gas;
d. a plurality of gas emitters connected to the compressor and adapted to be disposed near the plants, whereby during use, the gas emitter emits a predetermined amount of Nitrogen gas and a predetermined amount of CO2 gas, in a mixture, to the plants, whereby a diffusion gradient is created in the plants moving Oxygen gas (O2) out of the plants and enhancing photosynthesis in the plants;
e. a gas flow control valve disposed between the compressor and the gas emitters;
f. at least one CO2 sensor and at least one O2 sensor disposed near the plants; and
g. an electronic control communicatively interconnected to the gas flow control valve, the at least one CO2 sensor, and the at least one O2 sensor, the electronic control provides a mixture of Nitrogen gas and CO2 gas to the plants such that, when emitted into ambient air surrounding the plants, creates a Minus O2 condition.

20. A method of enhancing the growth of plants growing in a green house, hoop house, or other enclosure by removing or reducing O2 in the ambient air surrounding the plants thereby creating a diffusion gradient in the plants, moving Oxygen gas (O2) out of the plants and enhancing photosynthesis in the plants.
